(19) United States
(12) Patent Application Publication
(10) Pub. No.: US 2013/0246727 A1
(43) Pub. Date: Sep. 19, 2013

(54) ELECTRONIC CIRCUIT AND ARBITRATION METHOD

(71) Applicant: PFU LIMITED, Kahoku-shi (JP)

(72) Inventor: Atsushi Hikono, Kahoku-shi (JP)

(73) Assignee: PFU LIMITED, Kahoku-shi (JP)

(21) Appl. No.: 13/715,607

(22) Filed: Dec. 14, 2012

(30) Foreign Application Priority Data
Mar. 19, 2012 (JP) 2012-062255

(51) Int. Cl. G06F 12/14

(52) U.S. Cl. CPC G06F 12/14
USPC 711/163

(57) ABSTRACT

An electronic circuit including, a plurality of memory masters that access a memory, and an arbitration circuit that arbitrates between the plurality of memory masters requesting access to the memory. The arbitration circuit performs the following processing, when one of the plurality of memory masters has succeeded in accessing the memory, priority of the one memory master is decreased, and priority of the other one of the plurality of masters is increased, for each of the plurality of memory masters, a correction value to be applied to the priority is determined according to the number of accesses made to the memory during a certain past period, and permission to access the memory is granted to a memory master selected from along the plurality of memory masters according to the priority corrected by adding the correction value.

### CROSS-REFERENCE TO RELATED APPLICATIONS

This application is based upon and claims the benefit of priority of prior Japanese Patent Application No. 2012-062255, filed on Mar. 19, 2012, the entire contents of which are incorporated herein by reference.

### TECHNICAL FIELD

The embodiments discussed herein are related to arbitration for memory access from a plurality of memory masters.

### BACKGROUND

When a plurality of memory masters use a shared memory resource, arbitration is performed to resolve competing memory access from the plurality of memory masters. In the following description, such a memory master may be simply referred to as “master” or “master device.”

In the prior art of memory access arbitration, an arbiter is known that provides arbitration between master devices so as to allow each master device to access a shared memory with a predetermined bandwidth. The arbiter includes an accepting means for accepting a request for access to a shared memory from a specific master device, and an access control means. When an access request with a bandwidth larger than a preallocated bandwidth is accepted from the specific master device by the accepting means, the access control means grants the request during a predefined first period, and when the first period ends, the access control means masks the access request from the specific master device during a second period that follows the first period.

Related art is disclosed in Japanese Laid-open Patent Publication No. 2009-271944.

### SUMMARY

In the case of the above prior art arbitration process in which, when an access request with a bandwidth larger than a preallocated bandwidth is accepted from a master, the accepted access request is masked during the second period, an unbalance may occur in terms of the average amount of data transfer permitted between different masters having different ways of memory access. For example, a master that exhibits a fluctuation in the amount of data transfer to and from the memory is more likely to exceed the preallocated bandwidth than a master that does not exhibit such a fluctuation. As a result, even when the average amount of data transfer is the same between the two masters, the master that exhibits a fluctuation in the amount of data transfer is more likely to be masked.

Further, in the above prior art, masking is not finished until the access request exceeds the preallocated bandwidth. As a result, if there are two kinds of masters, a master that accesses periodically and an master that performs data transfer to and from the memory at a constant rate, the periodic access from the former may cause a dropout of data being transferred to and from the latter.

Furthermore, in the above prior art, once the access request is masked, it is not possible to access the memory even when there are no access requests from other masters; this can unnecessarily limit the signal processing capability of the master. In this way, the prior art has had the problem that when different kinds of masters having different ways of memory access attempt to access a shared memory, an access permission that matches the characteristics of each specific master is not provided.

An object of the apparatus and method disclosed herein is to improve the balance between the access permissions to be given to a plurality of memory masters having different ways of memory access.

According to an aspect of the embodiment, there is provided an electronic circuit including: a plurality of memory masters that access a memory; and an arbitration circuit that arbitrates between the plurality of memory masters requesting access to the memory. The arbitration circuit performs the following processing: when one of the plurality of memory masters has succeeded in accessing the memory, priority of the one memory master is decreased, and priority of the other one of the plurality of masters is increased; for each of the plurality of memory masters, a correction value to be applied to the priority is determined according to the number of accesses made to the memory during a certain past period; and permission to access the memory is granted to a memory master selected from along the plurality of memory masters according to the priority corrected by adding the correction value.

According to another aspect of the embodiment, there is provided an arbitration method for arbitrating between a plurality of memory masters requesting access to a memory. The arbitration method includes: when one of the plurality of memory masters has succeeded in accessing the memory, decreasing priority of the one memory master and increasing priority of the other one of the plurality of masters; for each of the plurality of memory masters, determining a correction value to be applied to the priority according to the number of accesses made to the memory during a certain past period; and granting permission to access the memory to a memory master selected from along the plurality of memory masters according to the priority corrected by adding the correction value.

According to the apparatus and method disclosed herein, it is possible to improve the balance between the access permissions to be given to the plurality of memory masters having different ways of memory access.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a hardware block diagram illustrating one example of an image reading apparatus.

FIG. 2 is a diagram illustrating one example of the functional configuration of an arbitration circuit.

FIG. 3 is a diagram illustrating one example of the functional configuration of a priority correcting unit.

FIG. 4A is a diagram illustrating one example of how the number of accesses is measured.

FIG. 4B is a diagram illustrating one example of access history information.

FIG. 5 is a diagram illustrating one example of an access history updating process.

FIG. 6 is a diagram illustrating one example of threshold value setting information stored in a threshold value storage unit.

FIG. 7 is a diagram illustrating one example of a correction value determining process.

FIG. 8 is a diagram illustrating one example of an arbitration method.

### DESCRIPTION OF EMBODIMENTS

### 1. Hardware Configuration

A preferred embodiment will be described below with reference to the accompanying drawings. An electronic circuit disclosed in this specification will be described by taking as an example a signal processing circuit used in an image reading apparatus that generates an image signal by reading a two-dimensional document. However, this example is not to be taken to mean that the electronic circuit disclosed in this specification is limited in its application to the signal processing circuit used in the image reading apparatus. Rather, the electronic circuit disclosed in this specification can be applied extensively to any electronic circuit that contains a plurality of masters that access a shared memory.

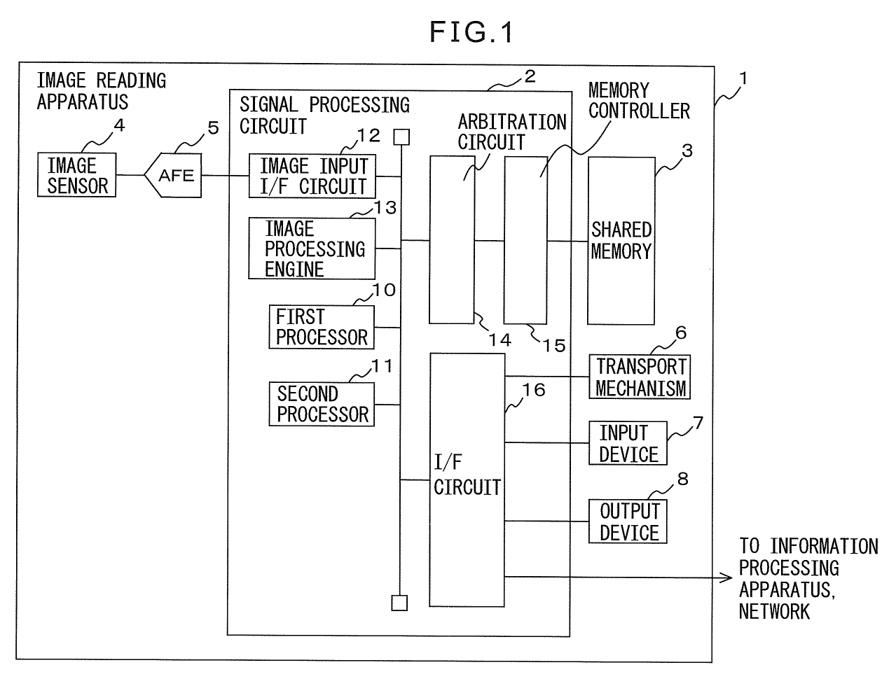

FIG. 1 is a hardware block diagram illustrating one example of the image reading apparatus. The image reading apparatus 1 may be, for example, an image reading apparatus that reads a two-dimensional document by scanning it with a plurality of light sources. Examples of such an image reading apparatus include various kinds of scanner devices such as a feeder scanner, flatbed scanner, handheld scanner, etc. An embodiment will be described below by taking a feeder scanner as an example. The hardware configuration illustrated in FIG. 1 is one example of the image reading apparatus disclosed in this specification. Any other suitable hardware configuration may be employed as long as the apparatus is configured to implement the operations described herein.

The image reading apparatus 1 includes, in addition to the signal processing circuit 2, a shared memory 3, an image sensor 4, an AFE (Analog Front-End Processor) 5, a transport mechanism 6, an input device 7, and an output device 8. The image sensor 4 captures an image of a two-dimensional document and outputs an image signal corresponding to the document. The image sensor 4 includes imaging devices, such as CCD (Charged Coupled Device) sensors or CMOS (Complementary Metal Oxide Semiconductor) sensors, arranged in a one-dimensional or two-dimensional array, and optics for focusing the image of the document onto the imaging devices. The AFE 5 applies amplification and other signal processing to the image signal output from the image sensor 4, and supplies the thus processed image signal to the signal processing circuit 2.

The transport mechanism 6 transports the document from a document tray provided in the image reading apparatus 1 to the position where the document is read by the image sensor 4. The input device 7 is a device that accepts a user input operation. The input device 7 may be, for example, a button, scroll wheel, keypad, keyboard, pointing device, touch panel, or the like. The output device 8 is a device that presents various kinds of information from the image reading apparatus 1 to the user. The output device 8 may be, for example, a display device that visually presents the information for viewing by the user. The output device 8 may be, for example, a display apparatus such as an LED display, liquid crystal display, organic electroluminescent display, or the like. Alternatively, the output device 8 may be an audio signal output speaker and its driving circuit.

The signal processing circuit 2 controls the image reading apparatus 1, takes as input the image data read by the image sensor 4, and applies image processing operations to the image data. The signal processing circuit 2 further controls the user interface of the image reading apparatus 1 using the input device 7 and the output device 8, and performs processing for communication with a network or an information processing apparatus connected to the image reading apparatus 1.

For that purpose, the signal processing circuit 2 includes a first processor 10, a second processor 11, an image input interface circuit 12, and an image processing engine 13. In the following description and the accompanying drawings, the interface may be designated as “I/F”. The first processor 10 is a control processor which controls the image reading apparatus 1 in accordance with the data and computer program stored in the shared memory 3.

The second processor 11 is an application processor which controls the user interface of the image reading apparatus 1 using the input device 7 and the output device 8 in accordance with the data and computer program stored in the shared memory 3. The second processor 11 further performs processing in accordance with the data and computer program stored in the shared memory 3 for communication with the network or the information processing apparatus connected to the image reading apparatus 1. The image input I/F circuit 12 is a logic circuit which takes as input the image data read by the image sensor 4 and transfers the image data to the shared memory 3. The image processing engine 13 is a logic circuit which applies image processing operations to the image data stored in the shared memory 3.

The first processor 10, the second processor 11, the image input I/F circuit 12, and the image processing engine 13 are masters that access the shared memory 3. In the following description, the first processor 10, the second processor 11, the image input I/F circuit 12, and the image processing engine 13 may be collectively referred to as the “master”. In the present embodiment, the four masters access the shared memory 3, but the electronic circuit disclosed in this specification can be applied to any electronic circuit that contains three or less masters or five or more masters that access the shared memory.

The signal processing circuit 2 further includes an arbitration circuit 14, a memory controller 15, and an I/F circuit 16. The arbitration circuit 14 arbitrates among the masters, i.e., the first processor 10, the second processor 11, the image input I/F circuit 12, and the image processing engine 13, requesting access to the shared memory 3. The memory controller 15 controls read and write operations to the shared memory 3 in accordance with the access request granted through arbitration by the arbitration circuit 14. The memory controller 15 further performs refresh operations on a DRAM (Dynamic Random Access Memory) incorporated in the shared memory 3.

The I/F circuit 16 drives a motor and an actuator in the transport mechanism 6 under the control of the first processor 10. Further, the I/F circuit 16 drives the input device 7 and the output device 8 under the control of the second processor 11. The I/F circuit 16 is also responsible for the transmission and reception of communication signals via a wired and/or wireless link between the second processor 11 and the information processing apparatus or the network.

The signal processing circuit 2 may be implemented, for example, in the form of a single system LSI (Large Scale Integration) chip on which the above component elements 10 to 16 are integrated. In an alternative embodiment, each or some of the component elements 10 to 16 may be implemented on a separate chip.

### 2. Functional Configuration of the Arbitration Circuit

Next, the arbitration circuit 14 will be described. The first processor 10, the second processor 11, the image input I/F circuit 12, and the image processing engine 13 respectively access the memory in different ways according to their differences in data transfer bandwidth, processing operation, cache capacity and organization, etc. The way of memory access is determined, for example, by the memory bandwidth for memory access, the access interval, and the data size per access.

For example, when the first processor 10 controls the image reading apparatus 1, or when the second processor 11 controls the user interface, memory access occurs in a bursty and sporadic manner involving real time processing, but the amount of data transfer averaged over time is small. On the other hand, when transferring image data from the image input I/F circuit 12 to the shared memory 3, it is desirable to ensure a constant transfer rate in order to prevent input image dropouts. By contrast, when the image processing engine 13 performs image processing, it is desirable to vary the transfer rate adaptively according to the situation because the amount of data written to or read from the shared memory 3 varies with time. The same is true for the case where the second processor 11 performs network communications.

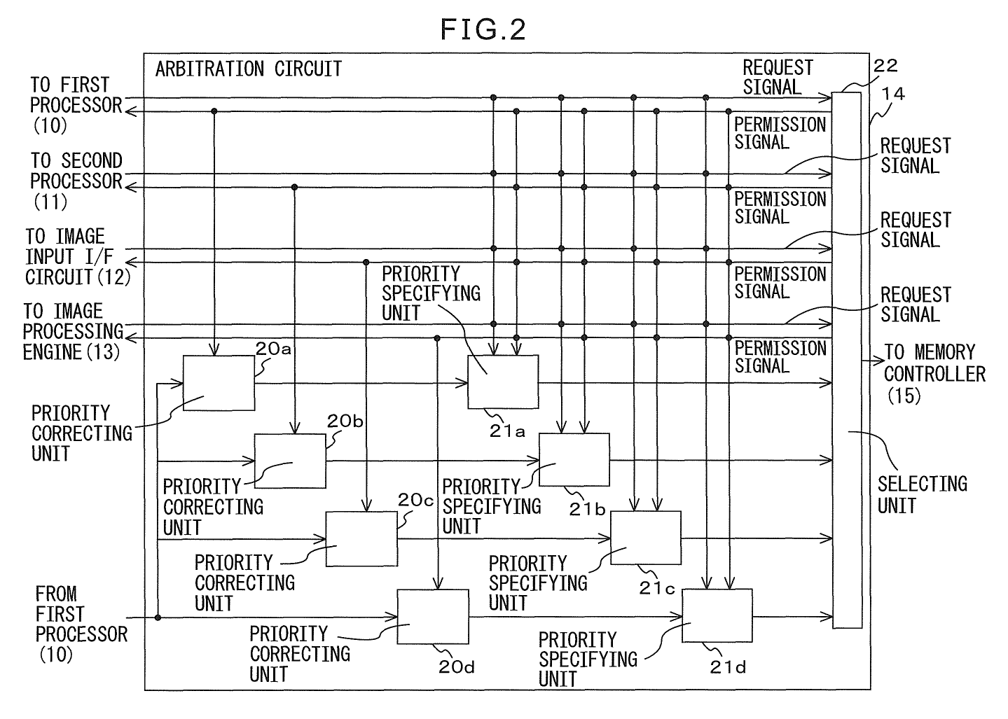

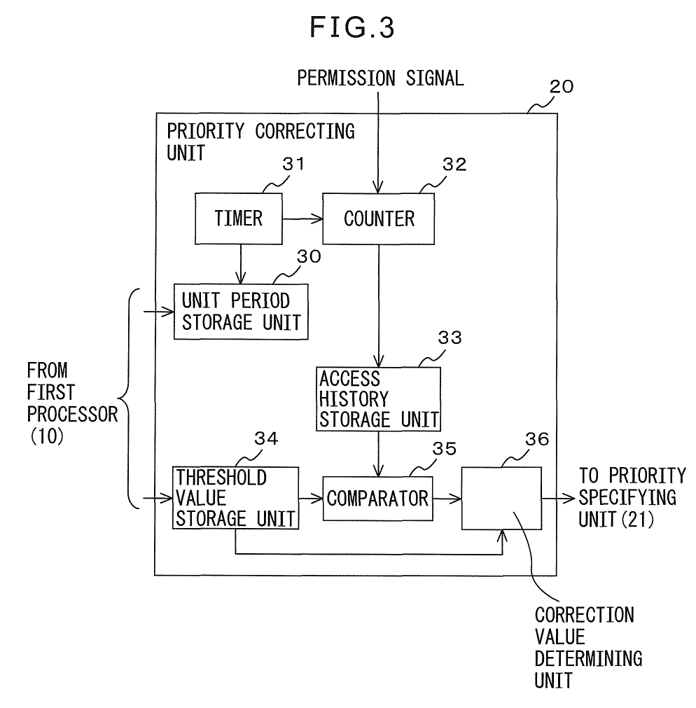

The arbitration circuit 14 improves the balance between the access permissions to be given to the plurality of memory masters having different ways of memory access, by correcting the access priority of each master in accordance with the number of accesses that the master made to the shared memory during a predefined past period. FIG. 2 is a diagram illustrating one example of the functional configuration of the arbitration circuit 14. The arbitration circuit 14 includes priority correcting units 20a to 20d, priority specifying units 21a to 21d, and a selecting unit 22. FIG. 2 is depicted by focusing on the functions related to the following description. The hardware whose functional configuration is described with reference to FIG. 2 may further include other functional units than those depicted. The same applies to the functional block diagram of FIG. 3.

The priority correcting unit 20a takes as input a permission signal that the selecting unit 22 outputs to permit the first processor 10 to access the shared memory 3. The priority correcting unit 20a counts the number of permission signals, thereby measuring the number of memory accesses made by the first processor 10 during the predefined past period. The priority correcting unit 20a compares the number of memory accesses with a threshold value and determines a correction value to be applied to the access priority of the first processor 10. The predefined period and the threshold value used here are set for each master by the first processor 10. In like manner, each of the other priority correcting units 20b, 20c, and 20d determines the correction value to be applied to the access priority of the second processor 11, the image input I/F circuit 12, or the image processing engine 13, respectively.

The priority specifying unit 21a takes as inputs the request signals with which the first processor 10, the second processor 11, the image input I/F circuit 12, and the image processing engine 13, respectively, request the selecting unit 22 for permission to access the shared memory 3, and the permission signals output in response to the respective request signals. The priority specifying units 21b, 21c, and 21d also operate in like manner. The correction values to be applied to the access priorities of the first processor 10, the second processor 11, the image input I/F circuit 12, and the image processing engine 13, respectively, are supplied to the respective the priority specifying units 21a, 21b, 21c, and 21d from the respective priority correcting units 20a, 20b, 20c, and 20d.

The priority specifying units 21a to 21d determine the access priorities of the respective masters, for example, in a round robin fashion. For example, when the access request from the first processor 10 is granted, the priority specifying unit 21a resets the access priority of the first processor 10 to the lowest level “0”. When the access request from the first processor 10 is not granted, and the permission signal to some other processor is received, the access priority of the first processor 10 is incremented by 1 from the current value. Likewise, the priority specifying units 21b to 21d determine the access priorities of the second processor 11, the image input I/F circuit 12, and the image processing engine 13, respectively.

The priority specifying units 21a to 21d correct the access priorities of the first processor 10, the second processor 11, the image input I/F circuit 12, and the image processing engine 13, respectively, by adding the correction values supplied from the respective priority correcting units 20a to 20d. The priority specifying units 21a to 21d supply the thus corrected access priorities to the selecting unit 22.

The selecting unit 22 takes as inputs the corrected access priorities output from the respective priority specifying units 21a to 21d. On the other hand, the selecting unit 22 receives a request signal requesting permission for accessing the shared memory 3 from one of the first processor 10, the second processor 11, the image input I/F circuit 12, and the image processing engine 13. The selecting unit 22 sends a permission signal to permit the requesting master to access the shared memory 3.

When such request signals are received from two or more masters among the first processor 10, the second processor 11, the image input I/F circuit 12, and the image processing engine 13, the selecting unit 22 selects the master having the highest access priority among the access priorities received from the priority specifying units 21a to 21d. The selecting unit 22 sends the permission signal only to the master selected from among the requesting masters in accordance with the access priority. The selecting unit 22 supplies to the memory controller 15 the memory access signal received from the master permitted to access.

In the following description, the priority correcting units 20a to 20d may be collectively referred to as the “priority correcting unit 20.” Likewise, the priority specifying units 21a to 21d may be collectively referred to as the “priority specifying unit 21.” The term “i-th master” may be used to refer to any one of the masters designated from among the first processor 10, the second processor 11, the image input I/F circuit 12, and the image processing engine 13, and the prefix “i” may be used to identify each individual master.

Next, one example of the functional configuration of the priority correcting unit 20 which determines the correction value to be applied to the access priority will be described with reference to FIG. 3. The priority correcting unit 20 includes a unit period storage unit 30, a timer 31, a counter 32, an access history storage unit 33, a threshold value storage unit 34, a comparator 35, and a correction value determining unit 36.

The unit period storage unit 30 stores set values for unit period Ti. The unit period Ti refers to each one of n equal periods into which the predefined period Tmi during which the number of memory accesses from the i-th master is measured is divided. The value for the unit period Ti is set for each master by the first processor 10. The timer 31 counts the unit period Ti. The counter 32 counts, for each unit period Ti, the number of memory accesses occurring from the i-th master within the unit period Ti.

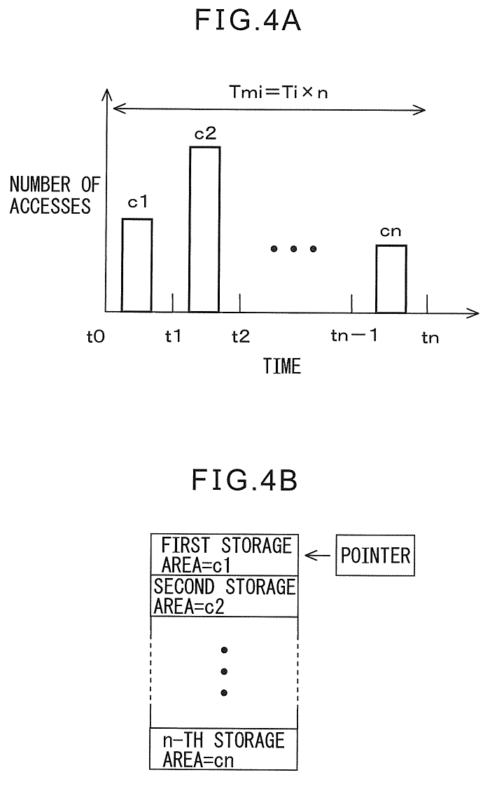

FIG. 4A is a diagram illustrating one example of how the number of accesses is measured by the counter 32. Times t0, t1, t2, . . . , tn-1, and tn define the unit periods Ti, i.e., the n equal periods into which the predefined period Tmi is divided. In the illustrated example, memory accesses have occurred c1 times, c2 times, and cn times in the respective n unit periods Ti, i.e., the unit periods t0 to t1, t1 to t2, . . . , tn-1 to tn, respectively.

The counter 32 stores the number of accesses counted for each unit period Ti in the access history storage unit 33. The access history storage unit 33 maintains n storage areas each for storing access history information representing data on the number of accesses counted for a corresponding one of the n contiguous unit periods Ti. FIG. 4B is a diagram illustrating one example of the access history information. In the illustrated access history information, the oldest access count c1 measured in the unit period t0 to t1 is stored in the first storage area, and the second oldest access count c2 measured in the succeeding unit period t1 to t2 is stored in the second storage area. The most recent access count cn measured in the unit period to-1 to tn is stored in the n-th storage area.

The access history storage unit 33 also stores a pointer that indicates the storage area storing the access count measured in the earliest unit period. The counter 32 updates the access history information each time the most recent access count is measured. When updating the access history information, the counter 32 stores the most recent access count by overwriting the contents of the storage area indicated by the pointer, and moves the pointer to indicate the storage area that stores the access count measured one unit period later than the overwritten access count. When the new access count is stored in the n-th storage area, the counter 32 moves the counter back to indicate the first storage area.

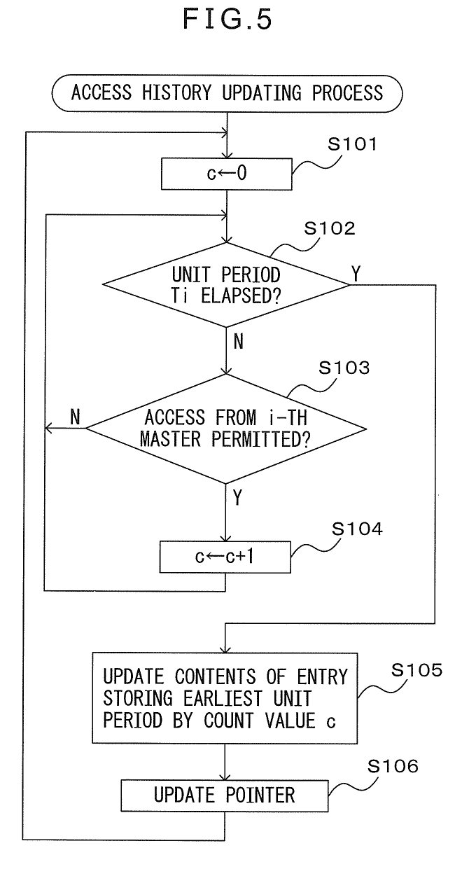

One example of the access history updating process performed by the counter 32 will be described with reference to FIG. 5. In step S101, the counter 32 resets the memory access count value c of the i-th master to “0”. In step S102, the counter 32 determines whether the unit time Ti has elapsed, completing the counting of the unit time Ti by the timer 31. When the unit time Ti has elapsed (Y in step S102), the process proceeds to step S105. When the unit time Ti has not elapsed yet (N in step S102), the process proceeds to step S103.

In step S103, the counter 32 determines whether the access from the i-th master is permitted or not. If the access from the i-th master is permitted (Y in step S103), the process proceeds to step S104. If the access from the i-th master is not permitted (N in step S103), the process returns to step S102. In step S104, the counter 32 increments the count value c by 1, after which the process returns to step S102.

In step S105, the counter 32 updates the contents of the storage area storing the access count measured in the earliest unit period by the count value c. In step S106, the counter 32 moves the pointer to indicate the storage area that stores the second oldest access count.

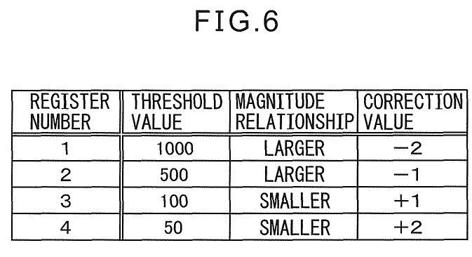

Reference is made to FIG. 3. The threshold value storage unit 34 stores threshold value setting information including the threshold value to be compared with the memory access count of the i-th master measured by the counter 32. FIG. 6 is a diagram illustrating one example of the threshold value setting information stored in the threshold value storage unit 34. The threshold value setting information is stored in a plurality of registers maintained in the threshold value storage unit 34. In the illustrated example, one set of threshold value setting information is stored in each of the registers designated by register numbers 1 to 4. In an alternative embodiment, the number of registers, i.e., the number of sets of threshold value setting information, may be less than 4 or more than 4.

Each set of threshold value setting information includes information elements “THRESHOLD VALUE”, “MAGNITUDE RELATIONSHIP”, and “CORRECTION VALUE”. The information element “THRESHOLD VALUE” indicates the threshed value with which the memory access count value is to be compared. The information element “MAGNITUDE RELATIONSHIP” is a flag indicating the magnitude relationship between the two values. The information element “CORRECTION VALUE” indicates the correction value to be applied when the memory access count of the i-th master satisfies the value specified in the information element “THRESHOLD VALUE” and the magnitude relationship specified in the information element “MAGNITUDE RELATIONSHIP”.

For example, according to the threshold value setting information stored in the first register, when the memory access count value is larger than the threshold value 1000, the correction value “−1” is applied. On the other hand, according to the threshold value setting information stored in the third register, when the memory access count value is smaller than the threshold value 100, the correction value “+1” is applied.

Reference is made to FIG. 3. The comparator 35 takes as inputs the threshold value, magnitude relationship, and correction value specified in the threshold value setting information and the n access counts stored as the access history information. The comparator 35 compares the sum of the n access counts with each threshold value specified in the threshold value setting information, and determines whether the relationship between the sum of the access counts and the threshold value satisfies the magnitude relationship specified for that threshold value. If the relationship between the sum of the access counts and the threshold value satisfies the magnitude relationship specified for that threshold value, the correction value determining unit 36 selects the correction value specified in the threshold value setting information, and supplies the selected correction value to the priority specifying unit 21 as the correction value ai to be applied to the access priority of the i-th master.

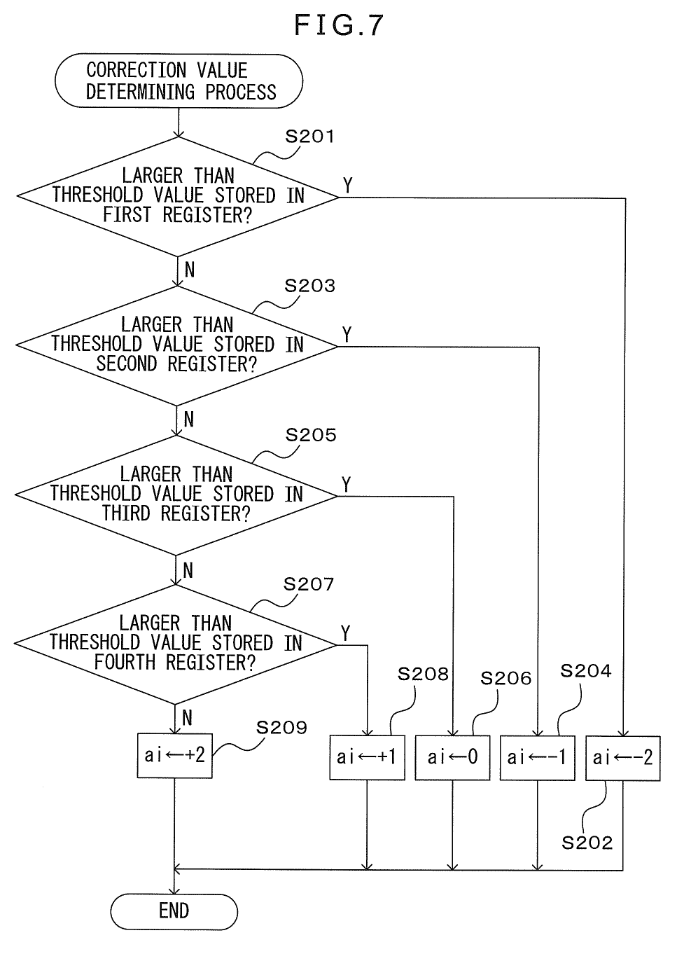

One example of the correction value determining process performed by the comparator 35 and the correction value determining unit 36 will be described with reference to FIG. 7. In step S201, the comparator 35 compares the sum of the n access counts with the threshold value stored in the first register. The threshold value setting information stored in the first register defines the magnitude relationship when the sum of the n access counts is larger than the threshold value “1000”. In the following description, the sum of the n access counts will be referred to simply as the “access count.”

If the access count is larger than the threshold value “1000” (Y in step S201), the process proceeds to step S202. If the access count is not larger than the threshold value “1000” (N in step S201), the process proceeds to step S203. In step S202, the correction value determining unit 36 selects the correction value “−2” specified in the first register, and supplies it to the priority specifying unit 21 as the correction value ai to be applied to the access priority.

In step S203, the comparator 35 compares the access count with the threshold value stored in the second register. The threshold value setting information stored in the second register defines the magnitude relationship when the sum of the access counts is larger than the threshold value “500”. If the access count is larger than the threshold value “500” (Y in step S203), the process proceeds to step S204. If the access count is not larger than the threshold value “500” (N in step S203), the process proceeds to step S205. In step S204, the correction value determining unit 36 supplies the correction value “−1” specified in the second register to the priority specifying unit 21.

In step S205, the comparator 35 compares the access count with the threshold value stored in the third register. The threshold value setting information stored in the third register defines the magnitude relationship when the sum of the access counts is smaller than the threshold value “100”. If the access count is larger than the threshold value “100” (Y in step S205), the process proceeds to step S206. If the access count is not larger than the threshold value “100” (N in step S205), the process proceeds to step S207. In step S206, the correction value determining unit 36 supplies the correction value “0” specified in the third register to the priority specifying unit 21.

In step S207, the comparator 35 compares the access count with the threshold value stored in the fourth register. The threshold value setting information stored in the fourth register defines the magnitude relationship when the sum of the access counts is smaller than the threshold value “50”. If the access count is larger than the threshold value “50” (Y in step S207), the process proceeds to step S208. If the access count is not larger than the threshold value “50” (N in step S207), the process proceeds to step S209. In step S208, the correction value determining unit 36 supplies the correction value “+1” specified in the fourth register to the priority specifying unit 21. On the other hand, in step S209, the correction value determining unit 36 supplies the correction value “+2” to the priority specifying unit 21.

### 3. Arbitration Method

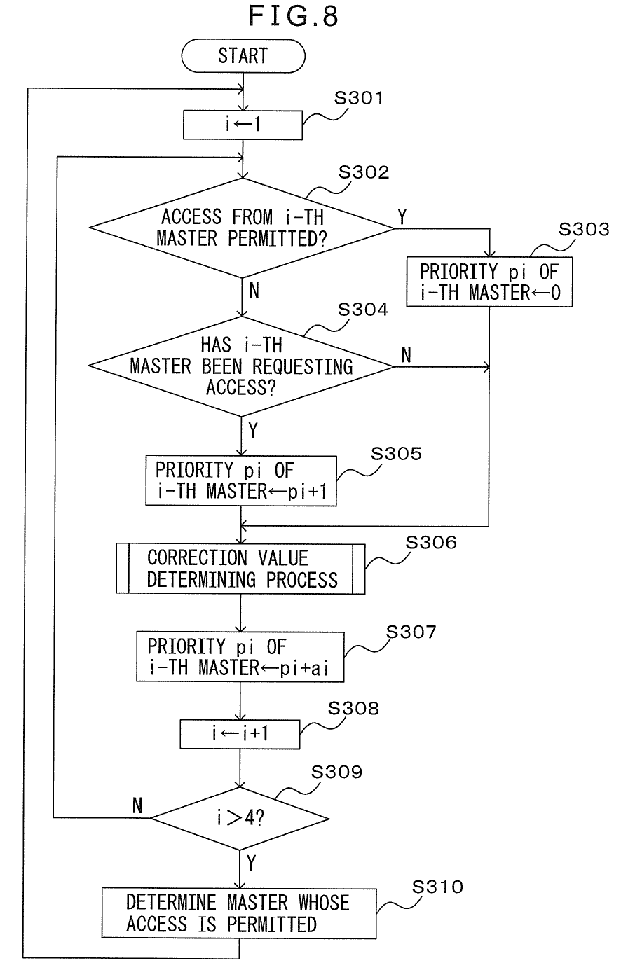

One example of the arbitration method disclosed in this specification will be described below with reference to the flowchart of FIG. 8. Since the access priority is determined for each master in the following process, each individual master is designated as the “i-th master” by using the prefix “i” for identifying the master under consideration.

In step S301, the value of the prefix “i” is initialized to “1”. In step S302, the priority specifying unit 21 determines whether the access from the i-th master is permitted by the selecting unit 22. If the access from the i-th master is permitted (Y in step S302), the process proceeds to step S303. If the access from the i-th master is not permitted (N in step S302), the process proceeds to step S304. In step S303, the priority specifying unit 21 sets the access priority pi of the i-th master to “0”. After that, the process proceeds to step S306.

In step S304, the priority specifying unit 21 determines whether the i-th master has been requesting access. If the i-th master has been requesting access (Y in step S304), the process proceeds to step S305. If the i-th master has not been requesting access (N in step S304), the process proceeds to step S306. In step S305, the priority specifying unit 21 increments the access priority pi of the i-th master by 1. After that, the process proceeds to step S306.

In step S306, the comparator 35 and the correction value determining unit 36 perform the correction value determining process of FIG. 7 to determine the correction value ai to be applied to the access priority pi of the i-th master. In step S307, the priority specifying unit 21 corrects the access priority pi by adding the correction value ai to the access priority pi of the i-th master.

In step S308, the value of the prefix is incremented by 1. In step S309, it is determined whether the value of the prefix “i” has exceeded the total number “4” of masters. If the value has exceeded the total number “4” of masters, i.e., if the process for the determination and correction of the access priority pi has been completed for all the masters (Y in step S309), the process proceeds to step S310. If the value has not yet exceeded the total number “4” of masters, the process returns to step S302.

In step S310, the selecting unit 22 permits the access requested from the master whose access priority pi is the highest of all the access-requesting masters. After that, the process returns to step S301. In the flowchart of FIG. 8, the access priority determination and correction process has been executed sequentially for the four masters, but alternatively, the access priority determination and correction process may be executed in parallel for the four masters. Further, the total number of masters may be three or less or five or more.

### 4. Effect of the Embodiment

According to the present embodiment, the access priority can be increased for a master whose access count measured during the predefined past period and stored in the access history information is smaller than the threshold value. As a result, the access from a master that makes memory access in a bursty and sporadic manner, for example, is preferentially permitted. By thus giving higher priority to a master that makes memory access in a bursty and sporadic manner, it becomes possible to prevent the access from such a master from becoming more likely to be denied than the access from a master that makes memory access with a steady data transfer rate; this serves to improve the balance between the access permissions to be given to the respective masters. For example, the access from a master, such as the first processor 10 or the second processor 11, that makes memory access in a periodic and sporadic manner can be given higher priority.

Similarly, the access from a master that exhibits a fluctuation in the amount of data transfer to and from the memory is prevented from becoming more likely to be denied than the access from a master that does not exhibit such a fluctuation, and the balance between the access permissions to be given to the respective masters can be improved. For example, the access from a master where the amount of data written to or read from the shared memory varies with time, such as the image processing engine 13 or the second processor 11, is prevented from becoming more likely to be denied than the access from a master that makes memory access with a constant transfer rate.

Further, by setting the threshold value setting information for each specific master, higher priority can be given to a master for which it is desired to ensure memory access with a constant transfer rate. For example, by giving higher priority to the memory access from the image input I/F circuit 12, the image input I/F circuit 12 can transfer image data to the shared memory 3 at a steady transfer rate, which serves to prevent input image dropouts.

On the other hand, for a master whose access count measured during the predefined past period is larger than the threshold value, correction is applied to decrease its priority level and thereby provide sufficient bandwidth for other masters to make access. However, since the access request is not completely masked, the access from the master whose access count is larger than the threshold value requests access is permitted if there is no access request from other masters. This serves to prevent the signal processing capability of the master whose access count is larger than the threshold value from being unnecessarily limited.

Further, since the predefined past period Tmi is divided into n unit periods Ti, and the access count measured in each unit period Ti is stored in the access history information, the interval at which the access history information is updated can be reduced to the unit period Ti which is shorter than the predefined past period Tmi. As a result, it becomes possible to determine the correction value based on the access history information measured for the longer predefined period Tmi, while on the other hand, making it possible to shorten the access history updating interval and use newer measurement results to determine the correction value.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An electronic circuit comprising:
a plurality of memory masters that access a memory; and
an arbitration circuit that arbitrates between the plurality of memory masters requesting access to the memory, wherein the arbitration circuit performs the following processing:
when one of the plurality of memory masters has succeeded in accessing the memory, priority of the one memory master is decreased, and priority of the other one of the plurality of masters is increased;
for each of the plurality of memory masters, a correction value to be applied to the priority is determined according to the number of accesses made to the memory during a certain past period; and
permission to access the memory is granted to a memory master selected from along the plurality of memory masters according to the priority corrected by adding the correction value.

2. The electronic circuit according to claim 1, wherein the arbitration circuit performs processing to determine the correction value in accordance with a result of a comparison made between a threshold value set for each of the memory masters and the number of accesses made during the certain period.

3. The electronic circuit according to claim 2, wherein the arbitration circuit comprises a storage circuit for storing the threshold value, a flag indicating a magnitude relationship, and correction value information, wherein when the threshold value and the number of accesses satisfy the magnitude relationship indicated by the flag, the value indicated by the correction value information is used as the correction value to be applied to the priority.

4. The electronic circuit according to claim 1, wherein the arbitration circuit comprises a second storage circuit for storing the number of accesses that occurred during each of a plurality of unit periods into which the certain period was divided, wherein the arbitration circuit performs processing to update for each of the unit periods the number of accesses stored in the second storage circuit, and processing to calculate the number of accesses made during the certain period by summing the number of accesses over the plurality of unit periods.

5. An arbitration method for arbitrating between a plurality of memory masters requesting access to a memory, comprising:
when one of the plurality of memory masters has succeeded in accessing the memory, decreasing priority of the one memory master and increasing priority of the other one of the plurality of masters;
for each of the plurality of memory masters, determining a correction value to be applied to the priority according to the number of accesses made to the memory during a certain past period; and
granting permission to access the memory to a memory master selected from along the plurality of memory masters according to the priority corrected by adding the correction value.
